(19) United States
(12) Patent Application Publication
(10) Pub. No.: US 2018/0285979 A1
(43) Pub. Date: Oct. 4, 2018

(54) CREATING SERVICE AGREEMENTS VIA BLOCKCHAIN SMART CONTRACTS

(71) Applicant: International Business Machines Corporation, Armonk, NY (US)

(72) Inventors: Amanda E. Chessell, Hants (GB); Elezaveta Koumpan, Ontario (CA)

(21) Appl. No.: 15/478,592

(22) Filed: Apr. 4, 2017

(51) Int. Cl. G06Q 40/08

(52) U.S. Cl. CPC G06Q 40/08

(57) ABSTRACT

A blockchain of transactions may be used for various purposes and may be later accessed by interested parties for ledger verification. One example method of operation may include one or more of receiving a request from a user device for a new agreement at a service provider server, identifying a type of service requested, retrieving service history information stored in a user profile associated with the user device, evaluating the service history information to create a smart contract defining a new service agreement, and storing the smart contract in a blockchain.

### TECHNICAL FIELD

This application generally relates to smart contracts in a blockchain, and more particularly, to creating service agreements via blockchain smart contracts.

### BACKGROUND

The blockchain may be used for various transactions due to the nature of the shared ledger system. Service industries may require diligence when evaluating new customers. For example, many service providers will attempt to identify past and present statuses of potential customers. For example, in the insurance industry, fraud related issues are a growing concern as there is no trust, transparency, and information is not readily shared. The insurance industry usually maintains all known data to include a previous history of a person who had a policy, made claims, terminated the policy, re-joined the policy, etc.

The consumer, in general, also does not have the ability to provide proof of his or her low risk profile and acceptable policy history. In fact, a likely candidate for an insurance provider may not be readily identified since only negative contextual information is generally stored in a database profile, which will likely lead to fewer agreements between parties. Also, in another scenario when a first policy is terminated and a second policy is enacted, the service provider companies may have a hard time identifying a personal risk profile since the previous data is not shared. Therefore, someone with a good policy without any claims and a regular payment history can be overlooked by a new service provider.

### SUMMARY

One example embodiment may include a method that includes one or more of receiving a request from a user device for a new agreement at a service provider server, identifying a type of service requested, retrieving service history information stored in a user profile associated with the user device, evaluating the service history information to create a smart contract defining a new service agreement, and storing the smart contract in a blockchain.

Another example embodiment may include an apparatus that includes one or more of a receiver configured to receive a request from a user device for a new agreement at a service provider server, and a processor configured to identify a type of service requested, retrieve service history information stored in a user profile associated with the user device, evaluate the service history information to create a smart contract defining a new service agreement, and store the smart contract in a blockchain.

Another example embodiment may include a non-transitory computer readable storage medium configured to store instructions that when executed cause a processor to perform one or more of receiving a request from a user device for a new agreement at a service provider server, identifying a type of service requested, retrieving service history information stored in a user profile associated with the user device, evaluating the service history information to create a smart contract defining a new service agreement, and storing the smart contract in a blockchain.

### BRIEF DESCRIPTION OF THE DRAWINGS

FIG. 1 illustrates an example of maintaining a ledger of user profile information in a blockchain ledger according to example embodiments.

FIG. 2 illustrates a system signaling diagram of accessing and evaluating a new service agreement per a request to establish a new agreement according to example embodiments.

FIG. 3A illustrates a flow diagram of an example method of accessing and evaluating a new service agreement in the blockchain according to example embodiments.

FIG. 3B illustrates a flow diagram of another example method of accessing and evaluating a new service agreement in the blockchain according to example embodiments.

FIG. 4 illustrates an example network entity configured to support one or more of the example embodiments.

### DETAILED DESCRIPTION

It will be readily understood that the instant components, as generally described and illustrated in the figures herein, may be arranged and designed in a wide variety of different configurations. Thus, the following detailed description of the embodiments of at least one of a method, apparatus, non-transitory computer readable medium and system, as represented in the attached figures, is not intended to limit the scope of the application as claimed, but is merely representative of selected embodiments.

The instant features, structures, or characteristics as described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “message” may have been used in the description of embodiments, the application may be applied to many types of network data, such as, packet, frame, datagram, etc. The term “message” also includes packet, frame, datagram, and any equivalents thereof. Furthermore, while certain types of messages and signaling may be depicted in exemplary embodiments they are not limited to a certain type of message.

The instant application relates to smart contracts in a blockchain, and more particularly, to establishing service agreements between service providers and users and using a public ledger (blockchain) to verify information and share the smart contract service agreements.

According to example embodiments, a service provider is not able to operate in isolation of potential customer records and previous transaction histories. A service provider must be enabled to perform diligence and accurately depict their future customers so underwriting and risk assessment departments can accurately identify customers who can help maintain the service provider's business model. A trusted relationship network is established with open trusted communication between service providers and service recipients. One example embodiment may include a system of recorded information for recording timely payment transactions, service agreement information and/or service claim correctness metrics, including timestamps, recorded events, evidence, etc.

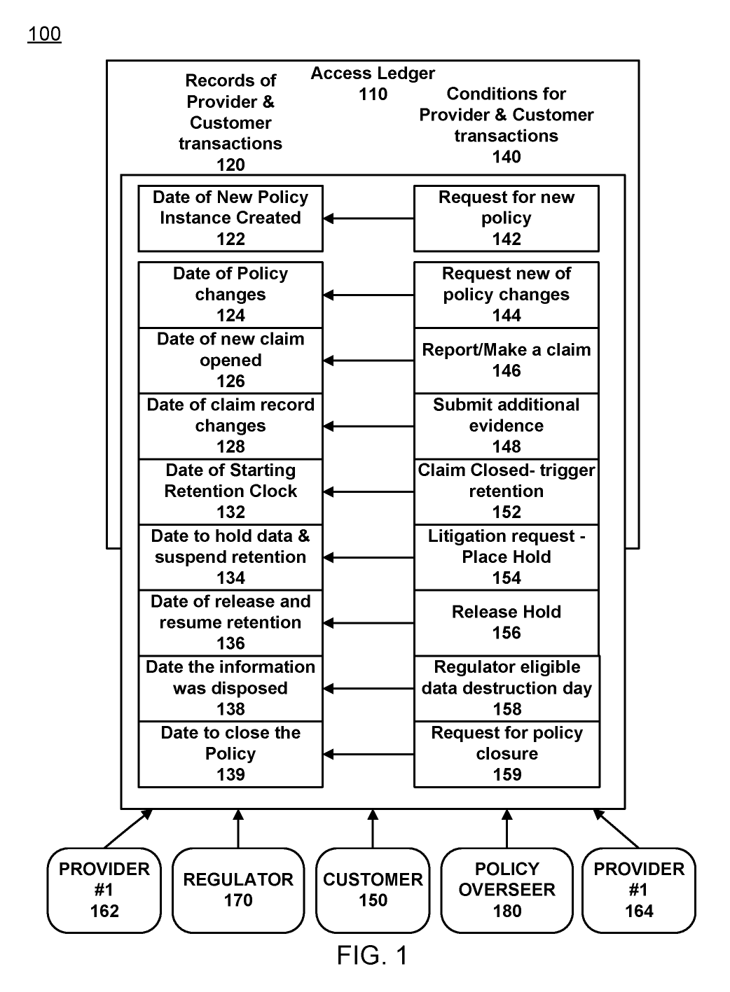

FIG. 1 illustrates an example of maintaining a ledger of user profile information in a blockchain ledger according to example embodiments. In FIG. 1, the ledger configuration and corresponding network 100 includes various parties with interest in obtaining access to a ledger 110. The ledger 110 in this case may be an insurance record associated with a user profile, such as a user account, business account or other entity which may seek insurance. The data may include a record of transactions 120 and conditions for the insurer and insured transactions 140. Examples of transactions may include a date a new policy agreement is created 122, a date a policy changes 124, a date a new claim is opened 126, a date a claim is recorded 128, a date a retention clock is initiated 132, a date to hold data and suspend retention 134, a date of release and resumed retention 136, date of an information disposal 138 and a date a policy was closed 139. The conditions 140 may include a request for a new policy 142, a request for changes 144, a report or claim instance 146, an evidence submission 148, a claim closing and trigger retention 152, a litigation request 154, a release hold 156, a data destruction record 158 and a request for a policy closure 159.

The providers 162 and 164 may be competing providers, which in this case are insurance companies, however, which could be any type of service provider organization offering any type of service according to the example embodiments. The other parties may include a regulator 170 which may need access to the ledger to identify accurate information and whether any of the information in the ledger is inaccurate or violates any established rule. The customer 150 may have access to his or her own history information as well. The policy overseer 180 may be assigned to determine whether a new policy, claim, or cancellation of a policy are being performed in valid manner and whether a user profile has the qualifications necessary to approve such transactions.

The customer 150 may have an ownership of his or her policy history that can be shared across a network between different insurance providers 162/164. The policies can be accumulated in the property history and governed by smart contracts. Once an evaluation of the user's history data is performed, a decision can be rendered based on risk assessment and if the assessment is acceptable to the service provider's standard, then an agreement may be setup as a contract in a publicly accessible smart contract stored in the blockchain between the provider and the customer. The smart contract is created when the request for a new policy agreement instance occurs. In the blockchain ledger, the customer will be able to offer evidence regarding all the previous communications, including records related to policies with claims, or policies without claims. This information will provide as a risk profile for Insured.

When creating a risk assessment, use information and other information related to loss history and a claim inquiry may be used to identify risk. Eligibility rules and underwriting associated rules may also be used. The rating is based on information about the policy transactions and associated costs. A rate is based on a variety of factors (i.e., the type of vehicle, the coverage terms selected, the date, state of residence, etc.). Also, a variety of other factors including the cost of the vehicle, the age of the driver, any previous claim history, etc. All of this data is used to identify a final rate. The access to the data is available for 3rd parties to calculate the risk and provide the rating based on the data in the blockchain. A base rating may be stored, however, that rating will depend on loss claims for a policy, which are also stored. If the loss claims are unacceptably high, the risk factor may be high, such as 0-10, with 10 being the highest. There may be more complex calculations depending on a set of jurisdictions in which a user can write a policy. If there are no losses, but it is a first time policy, and depending on the age of the driver, car cost and other factors, the rating still may be high. As a result, a base risk rate assessment will be adjusted based on the additional values.

In another example, a person or organization may have opened a new policy with a particular service provider. After some period of time, the insured closed the policy and switched to another insurance provider. With the blockchain, the customer may demonstrate to the service provider that he or she did not have any previous claims associated with the old policy, that the policy was paid, and as a result, that user is not high risk. The provider is able to access the previous history information with the blockchain ledger and can define the new policy as having a lower risk profile due to the lower risk information obtained from the ledger.

The potential customer of a potential future service agreement will be able to demonstrate a relative risk level which can be used by the insurance risk profile when closing policies and switching between insurance providers. This potential customer will be able to demonstrate nominal credentials and potentially receive an optima service agreement by demonstrating a low risk profile. One example may include an insurer providing a type of ‘proof’ to the regulator that they abide by the ‘good information management lifecycle’ by disposing all records and other data as required by known regulations. This approach may enable the creation of an optimal consumer/provider model, where a customer risk profile can be easily identified, preserved and verified, thus permitting the customer to receiver more optimal purchase options. The amount of fraud can also be minimized which provides more optimal negotiations. The service provider company will enforce governance with a proper audit record which includes a blockchain of all transactions related to a specific policy agreement. Policy transactions may include but are not limited to a quote, application, bind, issue, change, audit, cancel, rewrite, reinstate, and renew.

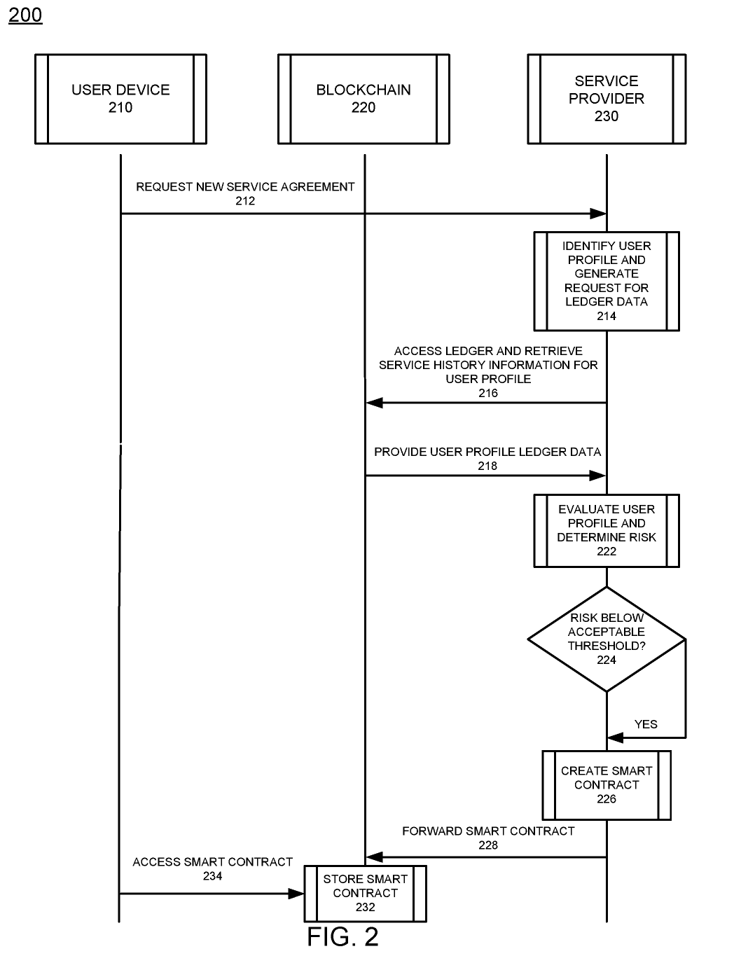

FIG. 2 illustrates a system signaling diagram of accessing and evaluating a new service agreement per a request to establish a new agreement according to example embodiments. Referring to FIG. 2, the system configuration 200 includes three primary entities including the user device 210 which represents the potential customer. The blockchain 220 which stores the ledger data of the customer. Also, the service provider 230 which represents one or more potential service providers which are competing for the customer's request for services, is also part of the system example of FIG. 2. In one example mode of operation, the user device 210 submit a request for a new service agreement 212. The request may be stored in the blockchain 220 and/or forwarded to interested service providers 230 which may include one or more service provider systems/service or other entities. The information can be processed by service provider which may identify a user profile associated with user device and may then invoke a diligence record of previous history stored in the blockchain ledger 214. The ledger is accessed based on the user profile 216 and all history information associated with the user profile is retrieved. The information is provided 218 to the requesting service provider 230. The service providers 230 may then evaluate the ledger data and determine whether the risk level is below the acceptable threshold 222. The user profiles which are below the acceptable threshold of risk may be considered potential agreement parties and the determination 224 can be made to create a smart contract 226 and forward 228 the smart contract to the blockchain 220 for storage 232 and subsequent access and agreement acceptance by the user device 234.

In other examples, operations may include recording all transactions in the blockchain once a contract is solidified. Such information may be included to include a request for new policy/policy renewal, a policy opened, incoming and outgoing communication dates, financial transaction dates (i.e., policy payments, claim payments), and litigation details. Other information includes a policy closed, a claim opened/closed, a police reports date, etc. Such information includes a timestamp, user names, geo-location, capturing the user details, such as particular user identification, actions performed by the user, a timestamp, success or failure of the action, supporting proof of the data origin, proof of submission of data, proof of transport of data and data delivery. Also, other information may include any customer dispute, phone calls, transactions related to communication with repair shops. For claim related data physical evidence data is also collected and stored. Such information may include paper files, which are documents and materials that assist in any subsequent settlement negotiations or litigation regarding the responsibility or amount of compensation to award for an accident. Such items are filed and maintained in specific folders known as ‘packages’ and include investigation and correspondence package, legal package, medical packages, etc. The personal belongings of a customer recovered from a vehicle may include example personal effects, CDs, etc. Items are generally collected in bags and delivered with a tag. Physical evidence may be vital to provide liability can include actual physical objects found or recovered from the accident scene and can be large items, such as glass or a vehicle part (e.g., car bumper). Items are collected or received by the estimator. A claim adjuster identifies if the investigation requires material evidence. Also, vehicle keys requested from customers on claims involving total theft. An insurer ships the key with a salvage tag attached. Vehicle plates are sent to salvage. They are submitted when they such items are either seized or removed from a total loss vehicle. General items may include a bicycle, baby seat, etc. Claim transactional activities include a claim recording, claim investigation, claim validation, claim anticipation and loss event maintenance, a benefit offering, a claim settlement, a service and claim status, and a claim recovery, and a special investigation unit, and also litigation unit transactions.

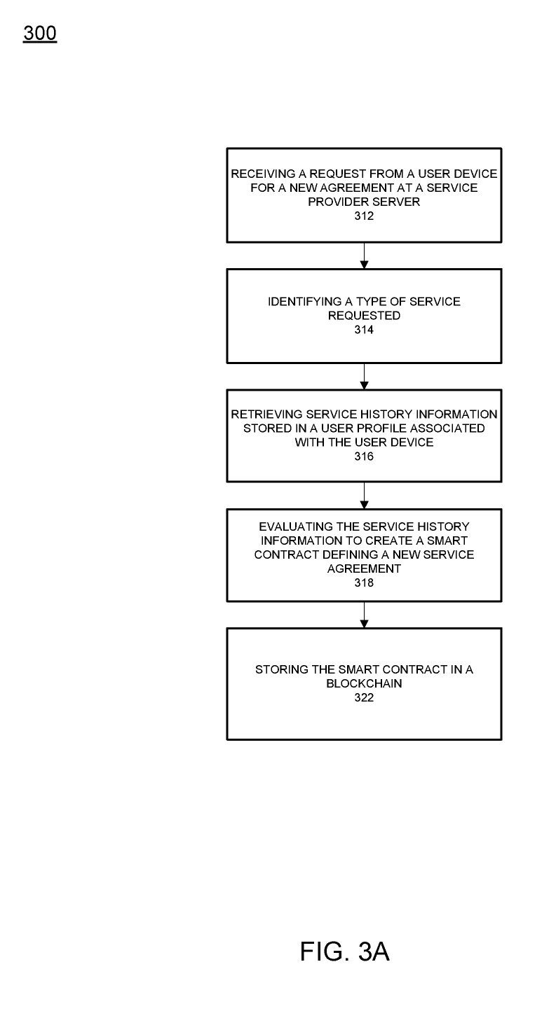

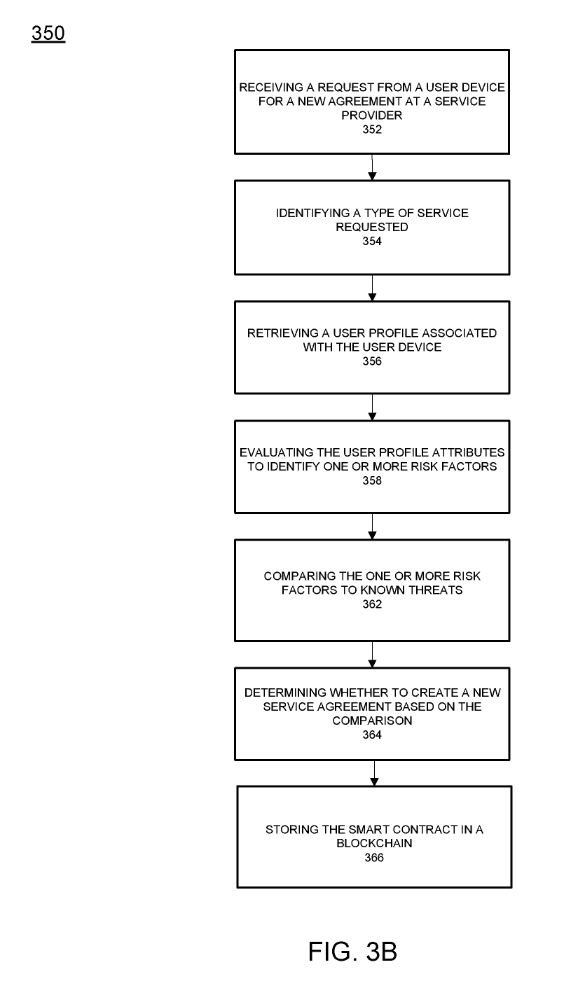

FIG. 3A illustrates a flow diagram 300 of an example method of accessing and evaluating a new service agreement in the blockchain according to example embodiments. Referring to FIG. 3A, the method may include receiving a request from a user device for a new agreement at a service provider server 312, identifying a type of service requested 314, retrieving service history information stored in a user profile associated with the user device 316, evaluating the service history information to create a smart contract defining a new service agreement 318, and storing the smart contract in a blockchain 322. The service history information may include a date that a previous service was created, a previous service was changed, a date a claim was submitted, a date a claim record was modified, a date a retention action occurred, a date a retention was suspended, a date a retention was resumed, a date information was disposed, and a date the previous service was closed, etc. All service history is stored in the blockchain collectively as it changes and updates occur. Information stored in the blockchain may include dates all claim payments are made, dates of all insured financial transactions, such as those having dates when policy payments were made, dates when a policy was changed, travel dates and location(s), if it is travel insurance policy, police reports filed, etc. There may be multiple previous services, and all such data is stored in the blockchain to include a history of all policy services events. The ledger is updated every time a transaction occurs through peer-to-peer replication.

The method may also include determining a level of risk associated with the new service agreement based on the service history information, and creating the smart contract when the level of risk is below a predetermined risk threshold. A policy contract may be crated even if the associated risk is considered above the threshold (i.e., high risk). The policy premium will be calculated differently, based on the calculated risk. In addition to a first service provider, a plurality of service providers may receive the request. The method may also include creating a plurality of smart contracts to store in the blockchain associated with the plurality of service providers, wherein each of the smart contracts comprises respective new service agreements. The method may also include identifying one or more predefined conditions required for a new service agreement, determining whether the service history information comprises the one or more predefined conditions, and creating the smart contract responsive to determining the one or more predefined conditions have been satisfied by the service history information. The predefined conditions could include one or more of a request for a new policy agreement, a request for policy agreement changes, and a submitted claim.

FIG. 3B illustrates another flow diagram 350 of another example method of accessing and evaluating a new service agreement in the blockchain according to example embodiments. Referring to FIG. 3B, the method includes receiving a request from a user device for a new agreement at a service provider server 352, identifying a type of service requested 354, retrieving a user profile associated with the user device 356, evaluating the user profile attributes to identify one or more risk factors 358, comparing the one or more risk factors to known threats 362 determining whether to create a new service agreement based on the comparison 364, and if so, storing the smart contract in a blockchain 366.

In this example, the risk factors may be one or more of a location of a user device (i.e., GPS, IP address, cellular location data, etc.). For instance, user devices located in suspect countries could easily be tagged as fraudulent activity or high risk. Also, device location could be used to identify a particular demographic of a user, which could then be corroborated for accurate assessment data and corresponding risk levels. Other risk factors may include frequency of transactions over a period of time, monetary size of the transactions, current currency in the digital wallet or blockchain account, and a credit score or personal activity history score of recent transactions. Those risk factor attributes can be identified from the ledger of mobile device and used to provide a more accurate risk assessment and service agreement.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

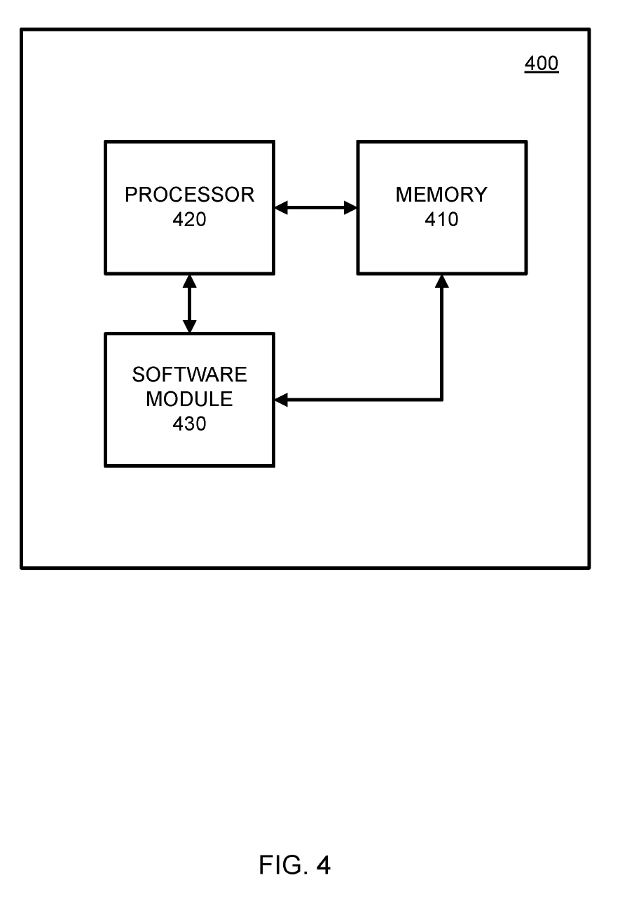

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example, FIG. 4 illustrates an example network element 400, which may represent or be integrated in any of the above-described components, etc.

As illustrated in FIG. 4, a memory 410 and a processor 420 may be discrete components of a network entity 400 that are used to execute an application or set of operations as described herein. The application may be coded in software in a computer language understood by the processor 420, and stored in a computer readable medium, such as, a memory 410. The computer readable medium may be a non-transitory computer readable medium that includes tangible hardware components, such as memory, that can store software. Furthermore, a software module 430 may be another discrete entity that is part of the network entity 400, and which contains software instructions that may be executed by the processor 420 to effectuate one or more of the functions described herein. In addition to the above noted components of the network entity 400, the network entity 400 may also have a transmitter and receiver pair configured to receive and transmit communication signals (not shown).

Although an exemplary embodiment of at least one of a system, method, and non-transitory computer readable medium has been illustrated in the accompanied drawings and described in the foregoing detailed description, it will be understood that the application is not limited to the embodiments disclosed, but is capable of numerous rearrangements, modifications, and substitutions as set forth and defined by the following claims. For example, the capabilities of the system of the various figures can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way, but is intended to provide one example of many embodiments. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed, but is merely representative of selected embodiments of the application.

One having ordinary skill in the art will readily understand that the above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A method comprising:
receiving a request from a user device for a new agreement at a service provider server;
identifying a type of service requested;
retrieving service history information stored in a user profile associated with the user device;
evaluating the service history information to create a smart contract defining a new service agreement; and
storing the smart contract in a blockchain.

2. The method of claim 1, wherein the service history information comprises a date a previous service was created, a previous service was changed, a date a claim was submitted, a date a claim record was modified, a date a retention action occurred, a date a retention was suspended, a date a retention was resumed, a date information was disposed, and a date the previous service was closed.

3. The method of claim 1, further comprising:
determining a level of risk associated with the new service agreement based on the service history information; and
creating the smart contract when the level of risk is below a predetermined risk threshold.

4. The method of claim 1, wherein a plurality of service providers may receive the request.

5. The method of claim 4, further comprising:
creating a plurality of smart contracts to store in the blockchain associated with the plurality of service providers, wherein each of the smart contracts comprises respective new service agreements.

6. The method of claim 1, further comprising:
identifying one or more predefined conditions required for a new service agreement;
determining whether the service history information comprises the one or more predefined conditions; and
creating the smart contract responsive to determining the one or more predefined conditions have been satisfied by the service history information.

7. The method of claim 6, wherein the predefined conditions comprise one or more of a request for a new policy agreement, a request for policy agreement changes, and a submitted claim.

8. An apparatus, comprising:
a receiver configured to receive a request from a user device for a new agreement at a service provider server;
a processor configured to:
identify a type of service requested;
retrieve service history information stored in a user profile associated with the user device;
evaluate the service history information to create a smart contract defining a new service agreement; and
store the smart contract in a blockchain.

9. The apparatus of claim 8, wherein the service history information comprises a date a previous service was created, a previous service was changed, a date a claim was submitted, a date a claim record was modified, a date a retention action occurred, a date a retention was suspended, a date a retention was resumed, a date information was disposed, and a date the previous service was closed.

10. The apparatus of claim 8, wherein the processor is further configured to:
determine a level of risk associated with the new service agreement based on the service history information; and
create the smart contract when the level of risk is below a predetermined risk threshold.

11. The apparatus of claim 8, wherein a plurality of service providers may receive the request.

12. The apparatus of claim 11, wherein the processor is further configured to:
create a plurality of smart contracts to store in the blockchain associated with the plurality of service providers, wherein each of the smart contracts comprises respective new service agreements.

13. The apparatus of claim 8, wherein the processor is further configured to:
identify one or more predefined conditions required for a new service agreement;
determine whether the service history information comprises the one or more predefined conditions; and
create the smart contract responsive to determining the one or more predefined conditions have been satisfied by the service history information.

14. The apparatus of claim 13, wherein the predefined conditions comprise one or more of a request for a new policy agreement, a request for policy agreement changes, and a submitted claim.

15. A non-transitory computer readable storage medium configured to store instructions that when executed cause a processor to perform:
receiving a request from a user device for a new agreement at a service provider server;
identifying a type of service requested;
retrieving service history information stored in a user profile associated with the user device;
evaluating the service history information to create a smart contract defining a new service agreement; and
storing the smart contract in a blockchain.

16. The non-transitory computer readable storage medium of claim 15, wherein the service history information comprises a date a previous service was created, a previous service was changed, a date a claim was submitted, a date a claim record was modified, a date a retention action occurred, a date a retention was suspended, a date a retention was resumed, a date information was disposed, and a date the previous service was closed.

17. The non-transitory computer readable storage medium of claim 15, wherein the processor is further configured to perform:
determining a level of risk associated with the new service agreement based on the service history information; and
creating the smart contract when the level of risk is below a predetermined risk threshold.

18. The non-transitory computer readable storage medium of claim 15, wherein a plurality of service providers may receive the request.

19. The non-transitory computer readable storage medium of claim 18, wherein the processor is further configured to perform:
creating a plurality of smart contracts to store in the blockchain associated with the plurality of service providers, wherein each of the smart contracts comprises respective new service agreements.

20. The non-transitory computer readable storage medium of claim 15, wherein the processor is further configured to perform:
identifying one or more predefined conditions required for a new service agreement;
determining whether the service history information comprises the one or more predefined conditions; and
creating the smart contract responsive to determining the one or more predefined conditions have been satisfied by the service history information, wherein the predefined conditions comprise one or more of a request for a new policy agreement, a request for policy agreement changes, and a submitted claim.
